(19) United States
(12) Patent Application Publication
(10) Pub. No.: US 2026/0179227 A1
(43) Pub. Date: Jun. 25, 2026

(54) SYSTEM AND METHOD FOR COLOR TONE IDENTIFICATION WITH SEGMENTATION IN AN IMAGE

(71) Applicant: Samsung Electronics Co., Ltd., Gyeonggi-do (KR)

(72) Inventors: Mostafa EL-KHAMY, San Diego, CA (US); Kareem METWALY, San Diego, CA (US)

(21) Appl. No.: 19/254,947

(22) Filed: Jun. 30, 2025

Related U.S. Application Data
(60) Provisional application No. 63/738,093, filed on Dec. 23, 2024.

(51) Int. Cl. G06T 7/11; G06T 7/194; G06T 7/90

(52) U.S. Cl. CPC G06T 7/11; G06T 7/194; G06T 7/90; G06T 2207/20081; G06T 2207/20084

(57) ABSTRACT

A method and device are provided in which a processor of an electronic device receives an image at a neural network configured with color tone categories. The processor generates a semantic segmentation map from an intermediate representation of the image from the neural network. The processor generates a color tone segmentation map from the intermediate representation. The color tone segmentation map is segmented based on a first color tone category. The processor determines a first score for the first color tone category from the color tone segmentation map. The first score indicates a prominence of the first color tone category in the image.

### CROSS-REFERENCE TO RELATED APPLICATION

This application claims the priority benefit under 35 U.S.C. § 119(e) of U.S. Provisional Application No. 63/738,093, filed on Dec. 23, 2024, the disclosure of which is incorporated by reference in its entirety as if fully set forth herein.

### TECHNICAL FIELD

The disclosure generally relates to image enhancement methods. More particularly, the subject matter disclosed herein relates to color tone identification and image segmentation improvements for image enhancement.

### SUMMARY

Image and video semantic segmentation involves assigning a category label to each pixel in an image or each frame in a video. A related but distinct task is color tone identification, which involves detecting and classifying the color tone of objects in images, including assessing the relative prominence of various color tone categories, such as, for example, dark-toned, medium-toned, and light-toned regions. These segmentation and identification tasks are critical for image signal processing pipelines, where accurate color tone information can help tune image parameters such as brightness, sharpness, and gamma correction. However, challenges arise due to biases in hue representation and the complexities of simultaneously segmenting tone-relevant features and predicting color tone scores in a unified framework.

To solve this problem, earlier approaches have utilized hue angles to assess tone-related biases (e.g., skin tone) and employed multidimensional color scales for fairness assessments. Other techniques have incorporated memory modules that store category-specific statistics to improve segmentation accuracy. Additionally, algorithms have been developed that separate the tasks of semantic segmentation from subsequent color tone prediction and regression. These methods typically treat color tone identification as a separate process or add significant complexity to the overall architecture.

One issue with the above-described approaches is that the decoupling of semantic segmentation and color tone prediction limits the ability to leverage shared, meaningful features inherent in the image. For example, separate segmentation and regression modules may lead to inconsistencies and reduced stability, particularly when the segmentation output is noisy or when partial predictions occur. Furthermore, the reliance on complex architectures or additional modules increases computational overhead and may not integrate easily with existing deep learning frameworks, thus hindering real-time performance in image and video processing applications.

To overcome these issues, systems and methods are described herein for concurrently performing semantic segmentation and color tone identification within a single deep neural network framework. A color tone segmentation module or head may be introduced at the end of a semantic decoder that segments image regions, such as human features, clothing or surfaces, into different color tone objects (e.g., dark, medium, and light). Additionally, a subsequent module may generate soft-values from this segmentation output, effectively regressing a continuous color tone confidence score that is normalized between 0 and 1. This dual-task formulation may be further reinforced by a dedicated regularization loss that guides both the segmentation and regression outputs, ensuring that the predicted color tone scores match expected values while maintaining high segmentation accuracy.

The above approach improves on previous methods because color tone prediction is directly integrated into the semantic segmentation pipeline, thus leveraging shared feature representations to enhance accuracy and stability. By adding minimal additional complexity, the proposed system may be incorporated into any pretrained deep learning-based image understanding architecture, requiring only a few extra layers to perform robust color tone regression alongside pixel-level classification. This unified method not only reduces computational resources but also improves the reliability of both segmentation maps and color tone confidence scores, ultimately enabling more accurate adjustments of image processing parameters and better overall image quality.

In an embodiment, a method is provided in which a processor of an electronic device receives an image at a neural network configured with color tone categories. The processor generates a semantic segmentation map from an intermediate representation of the image from the neural network. The processor generates a color tone segmentation map from the intermediate representation. The color tone segmentation map is segmented based on a first color tone category. The processor determines a first score for the first color tone category from the color tone segmentation map. The first score indicates a prominence of the first color tone category in the image.

In an embodiment, an electronic device is provided that includes a processor and a non-transitory computer readable storage medium storing instructions. When executed, the instructions cause the processor to receive an image at a neural network configured with color tone categories, generate a semantic segmentation map from an intermediate representation of the image from the neural network, and generate a color tone segmentation map from the intermediate representation. The color tone segmentation map is segmented based on a first color tone category. The instructions also cause the processor to determine a first score for the first color tone category from the color tone segmentation map. The first score indicates a prominence of the first color tone category in the image.

### BRIEF DESCRIPTION OF THE DRAWINGS

In the following section, the aspects of the subject matter disclosed herein will be described with reference to exemplary embodiments illustrated in the figures, in which:

FIG. 1 is a diagram illustrating an electronic device, according to an embodiment;

FIG. 2 is a diagram illustrating a network architecture modified to provide color tone scores, according to an embodiment;

FIG. 3 is a chart illustrating image color tone scores at different thresholds, according to an embodiment;

FIG. 4 is a flowchart illustrating a method for image enhancement, according to an embodiment;

FIG. 5 is a block diagram illustrating an example implementation of a color tone detection system within an image processing pipeline, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

Although the systems and methods described herein are discussed in the context of identifying and analyzing color tone, the disclosed techniques may also be applicable to detecting and processing other types of visual classification information. In some embodiments, the color tone corresponds to a skin tone, which is used herein as one illustrative example of color tone classification.

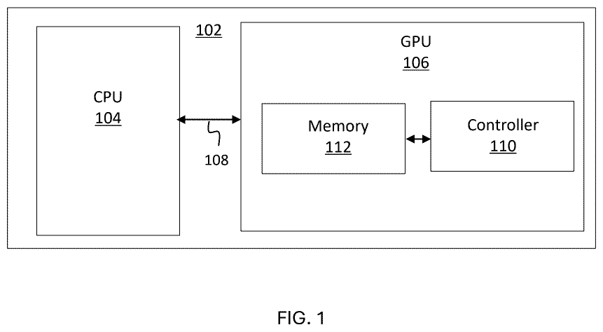

FIG. 1 is a diagram illustrating an electronic device, according to an embodiment. An electronic device (or user equipment (UE)) 102 may include multiple processing components that require efficient memory for management. The electronic device 102 may include a central processing unit (CPU) 104 and an accelerator, such as a graphics processing unit (GPU) 106, interconnected by a memory bus 108. These processing units rely on memory subsystems that must balance high-speed data access with low power consumption. For example, the GPU 106 may include a controller 110 (e.g., computational engines and processors) and a memory 112.

According to an embodiment, within the GPU 106, an efficient method is provided for identifying, classifying, and categorizing the relative prominence of color tone in an input frame in a single step. This method may be compatible with any deep learning-based image-understanding architecture to identify and regress the color tone confidence of an input image. The problem may be formulated as a segmentation problem, in which image regions, such as human features, with different color tones are treated as distinct segmentation objects. A module may be provided at the end of the network architecture to segment these color tone objects. The segmented areas corresponding to each color tone object may serve as a measure of that color tone's prominence. Another module may generate soft-values from the segmentation output, representing the proportion of the image that is dark-toned, medium-toned, light-toned, or not associated with tone-relevant features (e.g., skin or face regions). During training, a new regularization loss may be applied for color tone, ensuring that a final regressed output matches an expected distribution. A normalization function may be used to produce a single color tone score that is scaled between 0 and 1.

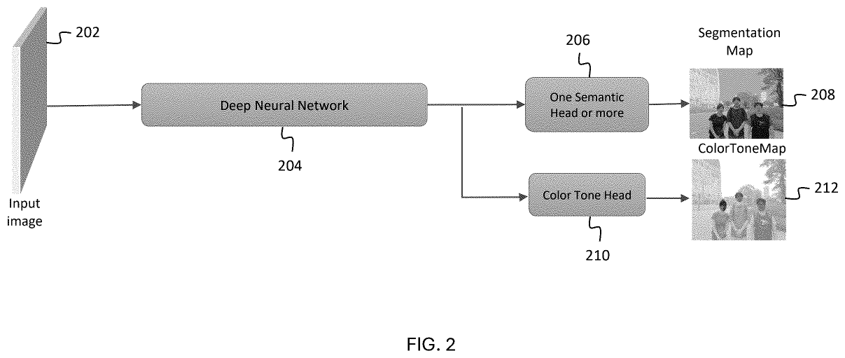

FIG. 2 is a diagram illustrating a network architecture modified to provide color tone scores, according to an embodiment. The color tone scores may be provided with minimal overhead. The network may be trained as a multitask network with multiple objectives or a single-task network solely focused on color tone score prediction using a dedicated head for this purpose. The following description of FIG. 2 illustrates an example embodiment in which the color tone corresponds to a skin tone, and categories such as light, medium, and dark skin tones may be detected and scored.

In FIG. 2, an input image 202 may be provided to a deep neural network 204. In one example, a dataset provided to the deep neural network 204 may be relabeled for skin tone using a pipeline that includes face detection, face extraction, race and skin tone classification, and propagation of such labels to the remaining skin regions. Pixels sharing the same skin tone classification may be grouped to form objects with the same skin tone label.

The deep neural network 204 may generate an intermediate representation of the input image 202. This representation may be characterized by increased channel depth and reduced spatial dimensions relative to the original input image 202.

The intermediate representation may be provided to at least one semantic segmentation head 206 to generate a semantic segmentation map 208. The semantic segmentation map 208 may segment foreground objects (e.g., cars, persons, cats/dogs) and background elements (e.g., buildings, sky, grass). Herein, the term “head” may refer to a subnetwork or branch designated to generate output for a particular task (e.g., a segmentation). The head may be a type of module dedicated to output generation.

Concurrently, the intermediate representation may also be fed to a color tone segmentation head 210, which generates a color tone segmentation map 212. In one embodiment, the map may segment some or all natural human parts, such as the face, hands, or hair, into distinct color tone objects (e.g., light, medium, and dark), with each object assigned a specific color tone value. For example, when the color tone corresponds to skin tone, categories such as light, medium, and dark skin tones may be used. The number of classes output by the color tone segmentation head 210 may vary depending on the application. For example, if the objective is to label dark, medium, and light skin tone categories, the color tone segmentation head 210 may be configured to output four classes, one for each of the skin tone categories and one for the rest-of-world (RoW), representing non-skin regions.

The color tone segmentation head 210 may output one or more color tone maps. Each map may correspond to a single color tone category (e.g., light, medium, or dark). The value of each pixel in a color tone map may represent the probability that the pixel belongs to that specific color tone. The color tone segmentation maps may also facilitate the determination of the relative prominence of each color tone in the image by using the area covered by each of the different color tones as a proxy for their prominence, while excluding non-relevant regions, such as RoW.

Specifically, an additional layer may be added to the color tone segmentation head 210 to output a single score for each color tone. This score may be derived by averaging or summing the pixel values in the corresponding color tone segmentation map 212, thereby serving as a proxy for that tone's prominence within in the image.

A normalization operation may be performed on the color tone scores to determine the relative prominence. The normalized score, obtained by calculating the ratio of the color tone scores, yields a value between 0 and 1.

For example, a normalization operation such as softmax may be applied to the color tone segmentation map 212 to produce a probability distribution at each pixel. Global average pooling or any other average/sum operation may be applied to obtain a single value per color tone. This value represents the confidence of that color tone over the entire image, and may be referred to as a color tone score.

The following describes an example implementation of determining skin tone, and the equation below could be applied to any other type of color tone on objects. Since face-parts and skin regions do not usually take up the majority of an image, a function may be used to normalize a color tone score over relevant regions (e.g., skin and face-parts), excluding unrelated regions (e.g., RoW)). The normalized skin tone score may be calculated as set forth in Equation (1) below (e.g., for dark skin tone):

$${Normalized\_SkinScore}_{dark} = \{ \begin{matrix}\frac{Dark Area}{Face + Skin Area} & if \frac{Face + Skin Area}{Whole Area} > Th \\ 0 & otherwise\end{matrix} \qquad ( 1 )$$

where Dark Area may be determined by computing the mean (global average pool or sum operator) over the spatial dimensions of the dark color tone prediction feature (e.g., dark logits). In an embodiment where color tone corresponds to skin tone, the Face+Skin Area may be the sum of all skin areas (e.g., Dark Area+Medium Area+Light Area), each computed in a similar manner with their corresponding skin tone logit features (i.e., all channels except for RoW—no face or skin). Whole area may refer to the total number of pixels in the image. Dark skin tone is used as an example herein, but this function may be applied for other skin tone categories (e.g., light and/or medium) or other types of color tone depending on the use case.

The threshold Th may be used to set the score to 0 when the contribution of tone-relevant regions (e.g., skin or face) is very low per image, such as when no human subjects are present. This may be useful for numerical stability and for removing outliers.

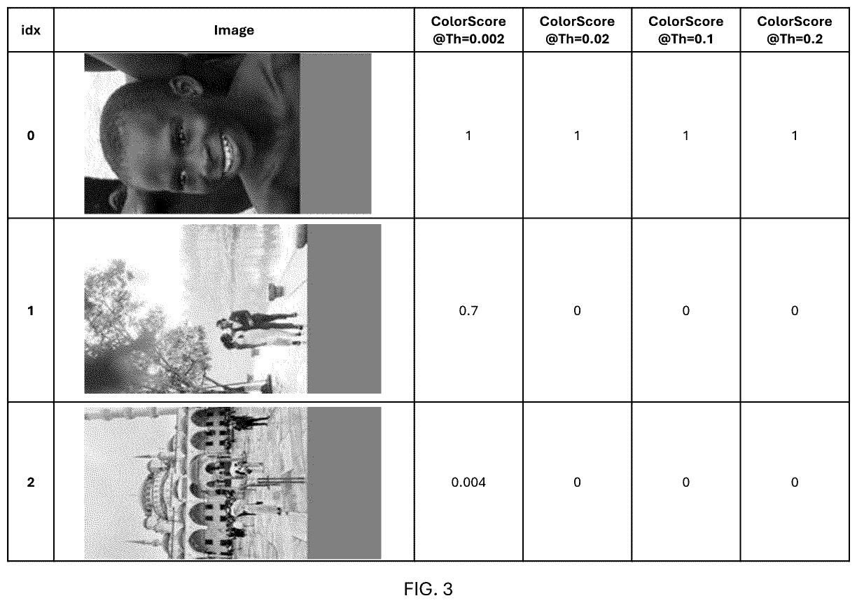

FIG. 3 is a chart illustrating image color tone scores at different thresholds, according to an embodiment. Image-0 maintains a color tone score of 1 across different thresholds (e.g., Th=0.002, 0.02, 0.1, and 0.2). The color tone score of 1 demonstrates that the measured color tone is the only dominant tone in the image, and that the area associated with the corresponding color tone category relative to the total image area exceeds the thresholds. Image-1 has a color tone score of 0.7 at a threshold of 0.002, and the color tone score decreases to 0 as the threshold increases (e.g., 0.02, 0.1. and 0.2). Similarly, Image-2 has a color tone score of 0.004 at a threshold of 0.002, and the color tone score decreases to 0 as the threshold increases (e.g., 0.02, 0.1, and 0.2). These two examples demonstrate different color tone scores at a low threshold, but a relevant tone region with respect to the total image area that does not exceed the second threshold 0.02, resulting in a color tone score of 0.

With respect training losses, multiple losses may be adopted during training to learn the correct predictions. Training losses may be divided into segmentation losses and regression losses.

Segmentation losses may be any type of training loss used to obtain an accurate semantic segmentation map prediction (e.g., cross-entropy loss, semantic boundary loss, and/or temporal semantic boundary loss). Semantic training loss may be used only for the color tone head module or for each head module output, as shown in Equations (2), (3), and (4) below.

$${L}_{ST - semantic} = {α}_{CE}^{ST} CrossEntropy ( {y}_{seg}^{ST} , {\hat{y}}_{seg}^{ST} ) + {α}_{SBL}^{ST} SBL ( {y}_{seg}^{ST} , {\hat{y}}_{seg}^{ST} ) + {α}_{tsbl}^{S T} TSBL ( {y}_{seg}^{ST} , {\hat{y}}_{seg}^{ST} ) + … \qquad ( 2 )$$

$${L}_{MH - semantic} = {α}_{CE}^{MH} CrossEntropy ( {y}_{seg}^{MH} , {\hat{y}}_{seg}^{MH} ) + {α}_{SBL}^{MH} SBL ( {y}_{seg}^{MH} , {\hat{y}}_{seg}^{MH} ) + {α}_{tsbl}^{MH} TSBL ( {y}_{seg}^{MH} , {\hat{y}}_{seg}^{MH} ) + … \qquad ( 3 )$$

$${L}_{semantic - total} = {L}_{ST - semantic} + {L}_{MH - semantic} \qquad ( 4 )$$

where ST is color tone head and MH means is main head.

$${y}_{seg}^{ST}$$

is the groundtruth segmentation map for the skintone head and

$${\hat{y}}_{seg}^{ST}$$

is the segmentation prediction for the skintone head. Similarly,

$${y}_{seg}^{MH}$$

is the groundtruth segmentation map for the main head and

$${\hat{y}}_{seg}^{MH}$$

is the segmentation prediction for the main head.

$${α}_{CE}^{ST} , {α}_{SBL}^{ST} , {α}_{tsbl}^{ST} , {α}_{CE}^{MH} , {α}_{SBL}^{MH} and {α}_{tsbl}^{MH}$$

are scalars representing the weights for their corresponding losses. Since there may be one or more heads, the L_{MH_semanic} term may be repeated multiple times according to the number of heads in the design.

With respect to the semantic training loss, a semantic prediction y_{seg} may be compared with a ground-truth (GT) segmentation map ŷ_{seg}, having dimension W×H, where W and H are the width and height of the input frame or a corresponding downsampled version corresponding to the output sized from the last layer. Values may range from 0 to L, where 0 corresponds to no-color tone, and L corresponds to number of color tone labels.

With respect to regression losses, L1 and/or L2 losses may be used to regularize the final color tone regression output to match the GT as set forth in Equation (5) below:

$${L}_{regression} = {{α}_{l 2} ( {y}_{reg}^{ST} - {\hat{y}}_{reg}^{ST} )}^{2} + {α}_{l 1} \vert {y}_{reg}^{ST} - {\hat{y}}_{reg}^{ST} \vert \qquad ( 5 )$$

In the color tone regression loss, the final regressed vector y_{reg} may compared with its corresponding GT ŷ_{reg}.

The final total loss may be described as set forth in Equation (6) below:

$${L}_{total} = {L}_{s emantic - total} + {L}_{regression} \qquad ( 6 )$$

The regression loss idea may be extended to cover multiple possible regression/identification problems that may work in tandem with the semantic segmentation problem. α's represent various weights for each training loss term.

$${y}_{reg}^{ST}$$

corresponds to the 1×(L+1) vector which has the color tone scores calculated from the labels using one hot label counting and area normalization, while

$${\hat{y}}_{reg}^{ST}$$

is the one calculated by pooling of predictions as shown above.

There may be different manners of post processing for the color tone segmentation.

The final color tone score may be predicted in an alternative manner by finding a maximum class between different color tone predictions instead of normalizing them through softmax. Accordingly, argmax may be applied to obtain a hard threshold for each pixel. This corresponds to counting the pixels predicted for each color tone, which corresponds to the area. This process may be simplified with the global average pooling operator to obtain the relative area occupied by each color tone, which is a soft value.

The temperature of softmax may be tuned so that it is more (or even less) confident in its predictions. Using a very high temperature may reduce this approach to the alternative approach above.

Another approach that may boost color tone detection is the use of an algorithm to boost the confidence in color tone. Since color tone subjects may look similar, they may compete with each other, which may result in the RoW class dominating them. The following method combines the confidence between all color tones before comparing them with RoW. Only in areas where the combined color tone confidence exceeds RoW, is the color tone identification then executed, to find the relative color tone scores. The per-pixel probabilities may be computed using softmax. If RoW (non-color tone) probability≤the sum of all color tone probabilities, the prediction may be set as the maximum class between color tones only (i.e., exclude RoW from selection). The prediction may be the maximum class between all outputs (color tones and RoW).

Another approach is to perform argmax as the first approach, but sum the number of pixels of each, and take a hard threshold (e.g., the final output is either 0 or 1 instead of a soft value, if the number of pixels classified as a specific color tone exceeds a threshold of minimum area). This approach reduces the regression problem into a classification problem.

The main segmentation head may be utilized by extracting tone-relevant segmentation features from the main head. The predictions of these pixels may be obtained from the secondary color tone head.

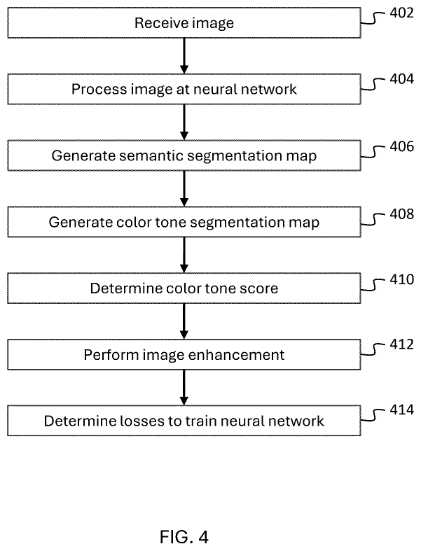

FIG. 4 is a flowchart illustrating a method for image enhancement, according to an embodiment. At 402, an image or video frame is received. At 404, a deep neural network may process the image or frame to generate an intermediate representation (e.g., a representation with increased channel depth and reduced spatial dimensions). At 406, the intermediate representation may be fed to a semantic segmentation module to produce a semantic segmentation map for general objects (foreground and background). At 408, the intermediate representation may be fed to a color tone segmentation head to generate a color tone segmentation map. The color tone segmentation map may segment the image into distinct color tone objects (e.g., dark, medium, light, and non-skin regions). At 410, an operation may be applied to the color tone segmentation map to obtain a probability distribution at each pixel for each color tone and to consolidate the pixel-wise probabilities into a single score per color tone. The color tone scores may be normalized to generate a single, normalized color tone score between 0 and 1, representing the relative prominence of each color tone in the image. At 412, image processing or enhancement may be performed using the color tone scores. At 414, the network may be trained using a loss function that combines segmentation loss and color tone regression loss to ensure accurate segmentation and reliable color tone score prediction.

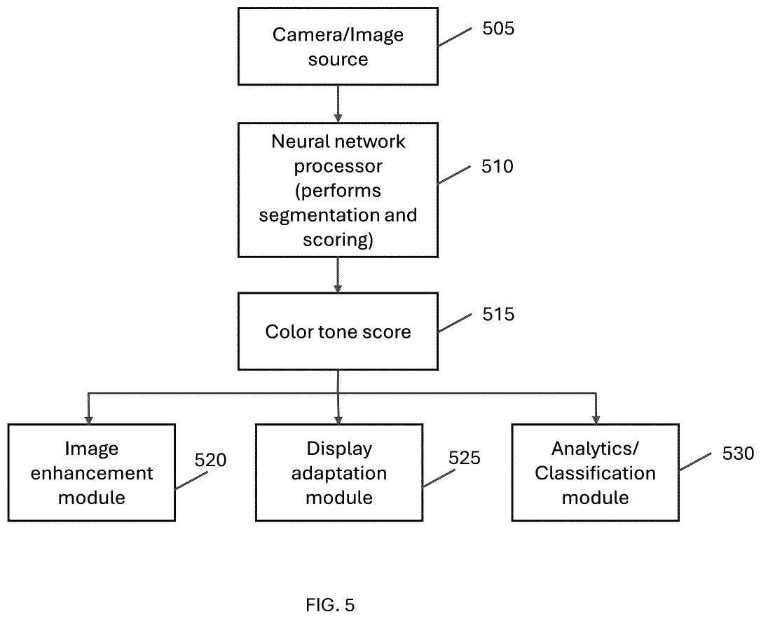

FIG. 5 is a block diagram illustrating an example implementation of a color tone detection system within an image processing pipeline, according to an embodiment. The system is configured to receive an image from a camera or image source 505, which may include any image-capturing component such as a mobile device camera, webcam, or image sensor. The image is then processed by a neural network processor 510 configured to perform semantic segmentation, color tone segmentation and scoring, as described above in connection with FIG. 2.

The neural network processor 510 may generate a color tone segmentation map and corresponding color tone score 515 from the image. As described previously, the color tone score 515 reflects the prominence of one or more color tone categories in the image. In some embodiments, the color tone corresponds to a skin tone, such as light, medium, or dark, while in other embodiments, the color tone may represent features such as hair, clothing, or background materials. The color tone score 515 may be normalized between 0 and 1 and computed using techniques such as softmax or argmax.

The color tone score 515 may then be provided to one or more modules. An image enhancement module 520 may adjust attributes of the image based on the color tone score 515, including contrast, brightness, gamma correction or sharpness, to improve the quality of the image. A display adaptation module 525 may use the color tone score 515 to adjust tone mapping or rendering settings for fairness-aware display output. For example, the display adaptation module 525 may adjust display parameters to better represent different skin tones, mitigating bias in real-time visual output.

Additionally, an analytics or classification module 530 may use the color tone score 515 to perform tasks such as tagging, content categorization, or fairness assessment in datasets used for machine learning. The modules 520-530 may be implemented on the electronic device 102 or used to generate data for cloud-based systems.

The system described in FIG. 5 integrates the color tone scoring functionality into a practical deployment environment and illustrates how the disclosed techniques improve image understanding, display control, and analytic workflows in real-world applications.

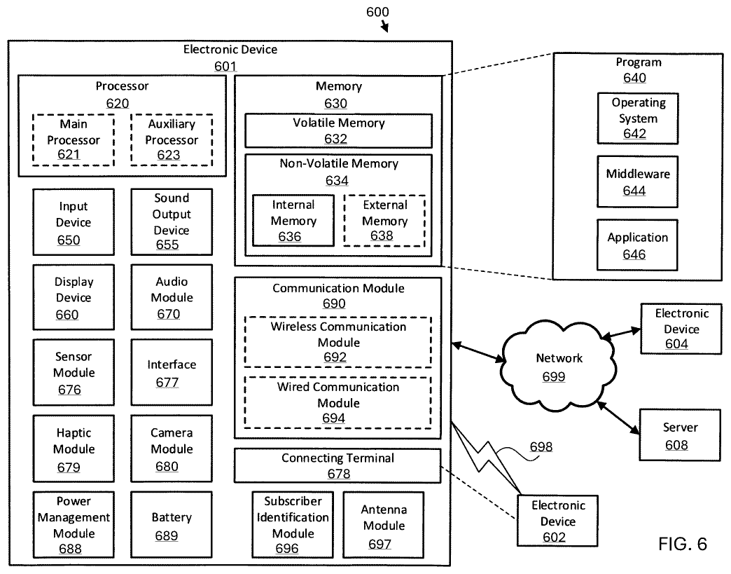

FIG. 6 is a block diagram of an electronic device in a network environment 600, according to an embodiment.

Referring to FIG. 6, an electronic device (or UE) 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, by a processor of an electronic device, an image at a neural network configured with color tone categories;
generating, by the processor, a semantic segmentation map from an intermediate representation of the image from the neural network;
generating, by the processor, a color tone segmentation map from the intermediate representation, wherein the color tone segmentation map is segmented based on a first color tone category; and
determining, by the processor, a first score for the first color tone category from the color tone segmentation map, wherein the first score indicates a prominence of the first color tone category in the image.

2. The method of claim 1, wherein the intermediate representation has increased channel depth and reduced spatial dimensions relative to the received image.

3. The method of claim 1, wherein the semantic segmentation map segments foreground and background objects in the image.

4. The method of claim 1, wherein the color tone segmentation map segments color areas in the image into color tone objects, and wherein each color tone object is assigned a color tone value for the color tone category.

5. The method of claim 1, wherein the score is determined based on a softmax normalization operation or an argmax operation.

6. The method of claim 5, wherein the score based on the softmax normalization operation comprises:
a first ratio of a first area in the image corresponding to the color tone category to a second area in the image corresponding to color areas, if a second ratio of the second area to a third area of the image is greater than a threshold; and
0 if the second ratio is less than or equal to the threshold.

7. The method of claim 1, further comprising:
determining, by the processor, training losses based on semantic training losses and regression losses; and
training, by the processor, the neural network to generate intermediate representations using the training losses.

8. The method of claim 1, further comprising:
performing, by the processor, image processing on the received image based on the determined score.

9. The method of claim 1, wherein the color tone segmentation map is segmented based on the first color tone category and a second color tone category, and further comprising:
determining, by the processor, a second score for the second color tone category from the color tone segmentation map, wherein the second score indicates a prominence of the second color tone category in the image.

10. The method of claim 1, wherein the neural network comprises a data set with labels for color tone categories.

11. An electronic device comprising:
a processor; and
a non-transitory computer readable storage medium storing instructions that, when executed, cause the processor to:
receive an image at a neural network configured with color tone categories;
generate a semantic segmentation map from an intermediate representation of the image from the neural network;
generate a color tone segmentation map from the intermediate representation, wherein the color tone segmentation map is segmented based on a first color tone category; and
determine a first score for the first color tone category from the color tone segmentation map, wherein the first score indicates a prominence of the first color tone category in the image.

12. The electronic device of claim 11, wherein the intermediate representation has increased channel depth and reduced spatial dimensions relative to the received image.

13. The electronic device of claim 11, wherein the semantic segmentation map segments foreground and background objects in the image.

14. The electronic device of claim 11, wherein the color tone segmentation map segments color areas in the image into color tone objects, and wherein each color tone object is assigned a color tone value for the color tone category.

15. The electronic device of claim 11, wherein the score is determined based on a softmax normalization operation or an argmax operation.

16. The electronic device of claim 15, wherein the score based on the softmax normalization operation comprises:
a first ratio of a first area in the image corresponding to the color tone category to a second area in the image corresponding to color areas, if a second ratio of the second area to a third area of the image is greater than a threshold; and
0 if the second ratio is less than or equal to the threshold.

17. The electronic device of claim 11, wherein the instructions further cause the processor to:
determine training losses based on semantic training losses and regression losses; and
train the neural network to generate intermediate representations using the training losses.

18. The electronic device of claim 11, wherein the instructions further cause the processor to:
perform image processing on the received image based on the determined score.

19. The electronic device of claim 11, wherein the color tone segmentation map is segmented based on the first color tone category and a second color tone category, and the instructions further cause the processor to:
determine a second score for the second color tone category from the color tone segmentation map, wherein the second score indicates a prominence of the second color tone category in the image.

20. The electronic device of claim 11, wherein the neural network comprises a data set with labels for color tone categories.
